(19) United States
(12) Patent Application Publication
(10) Pub. No.: US 2026/0220355 A1
(43) Pub. Date: Jul. 30, 2026

(54) TEXT STRING CREATION ASSISTANCE SYSTEM, TEXT STRING CREATION ASSISTANCE METHOD, AND TEXT STRING CREATION ASSISTANCE PROGRAM

(71) Applicant: STUDIO EURYGRAPH LTD., Nago-shi, Okinawa (JP)

(72) Inventor: Yutaka MORIISHI, Nago-shi, Okinawa (JP)

(21) Appl. No.: 19/159,014

(22) PCT Filed: Feb. 19, 2024
(86) PCT No.: PCT/JP2024/005710

§ 371 Date: Aug. 22, 2025

(30) Foreign Application Priority Data
Feb. 22, 2023 (JP) 2023-025821

(51) Int. Cl. G06F 40/166; G06F 3/0484; G06F 9/451

(52) U.S. Cl. CPC G06F 40/166; G06F 3/0484; G06F 9/451

(57) ABSTRACT

User convenience can be improved. An arithmetic processing system 1 includes a user terminal 3. The user terminal 3 displays a menu screen 100 for creating a text string constituting a text. The menu screen includes a keyword input section 110 which receives input of a keyword for text string creation, a first text string display section 120 which displays a text string related to the keyword for text string creation generated using a language model, a second text string display section 200 which is displayed side by side with the first text string display section 120 and displays a text string in an editable manner, and a text string selection button 133 which is displayed in association with the text string in the first text string display section 120. When the text string selection button 133 is selected, a duplicate text string 202 obtained by duplicating the corresponding text string is displayed in the second text string display section 200.

### TECHNICAL FIELD

The present invention relates to a text string creation assistance system, a text string creation assistance method, and a text string creation assistance program for assisting creation of a text string constituting a part or all of a text using a language model, for example.

### BACKGROUND ART

In recent years, a response system that receives character input and responds to the input characters with character information using a language model has been proposed. An example of this type of related art is disclosed in Patent Literature 1. In a response system of the related art, when a question sentence is input, text information regarding a question that is most appropriate in terms of text structure is automatically selected by a language model, and an answer having high similarity with the question is displayed.

However, in the response system of the related art, only an answer to the question can be obtained, and it is necessary to input the question as a text, and there is room for improvement from the viewpoint of user convenience.

### CITATION LIST

### Patent Literature

Patent Literature 1: JP 2022-180728 A

### SUMMARY OF INVENTION

### Technical Problem

In view of the above problems, an object of the present invention is to provide a text string creation assistance system, a text string creation assistance method, and a text string creation assistance program that can improve user convenience.

### Solution to Problem

The present invention is a text string creation assistance system, a text string creation assistance method, and text string creation assistance program, the text string creation assistance system including: a display device which displays a menu screen for creating a text string constituting a part or all of a text, in which the menu screen includes a keyword input section which receives input of one or more keywords, a keyword setting section which sets a keyword input to the keyword input section as a keyword for text string creation, a first text string display section which displays a text string related to the keyword for text string creation generated using a language model, a second text string display section which is displayed side by side with the first text string display section and displays a text string in an editable manner, and a text string selection button which is displayed in association with the text string in the first text string display section, and when the text string selection button is selected, processing proceeds to duplication processing of displaying, in the second text string display section, a duplicate text string obtained by duplicating the text string associated with the text string selection button.

### Advantageous Effects of Invention

According to the present invention, it is possible to provide the text string creation assistance system, the text string creation assistance method, and the text string creation assistance program that can improve user convenience.

### BRIEF DESCRIPTION OF DRAWINGS

FIG. 1 is an explanatory diagram illustrating an example of a configuration of a text string creation assistance system of the present invention.

FIG. 2 is an explanatory diagram of a screen configuration of a menu screen in an initial state.

FIG. 3 is an explanatory diagram of a screen configuration of the menu screen in a state where a keyword is input.

FIG. 4 is an explanatory diagram of a screen configuration of the menu screen in a state where a title candidate is displayed.

FIG. 5 is an explanatory diagram of a screen configuration of the menu screen in a state where a title is selected.

FIG. 6 is an explanatory diagram of a screen configuration of the menu screen in a state where a heading is displayed.

FIG. 7 is an explanatory diagram of a screen configuration of the menu screen in a state where the heading is selected.

FIG. 8 is an explanatory diagram of a screen configuration of the menu screen in a state where a body is displayed.

FIG. 9 is an explanatory diagram of a screen configuration of the menu screen in a state where the body is selected.

FIG. 10 is an explanatory diagram of a screen configuration of the menu screen in a case where a plurality of keywords are input.

FIG. 11 is an explanatory diagram of a screen configuration of the menu screen in a state where a keyword is input by a shortcut button.

FIG. 12 is an explanatory diagram of a screen configuration of the menu screen in a case where a registration data reading section is displayed.

FIG. 13 is an explanatory diagram of a screen configuration of the menu screen in a case where a hierarchical level designation section is displayed.

FIG. 14 is an explanatory diagram of a screen configuration of the menu screen in a case where a text type selection section is displayed.

### DESCRIPTION OF EMBODIMENTS

Hereinafter, an embodiment of the present invention will be described with reference to the drawings.

### System Configuration

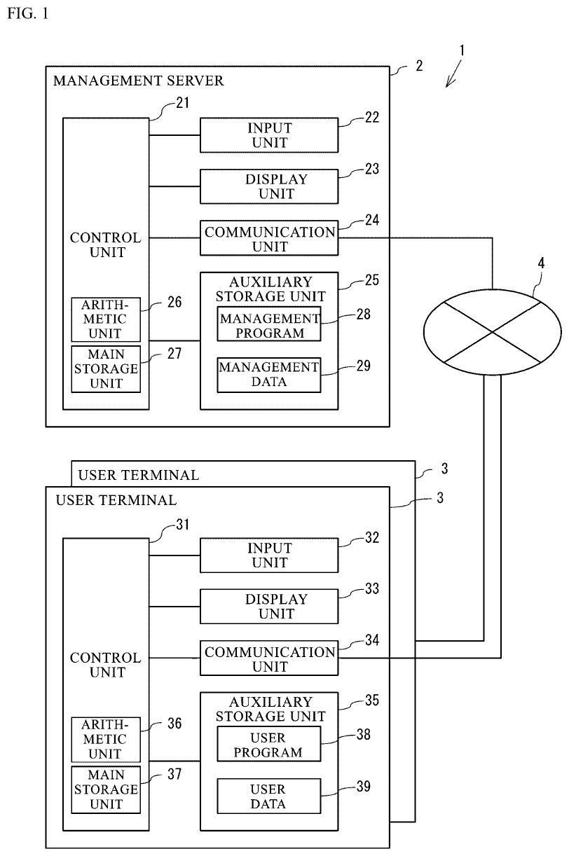

FIG. 1 is a block diagram illustrating an example of a system configuration of an arithmetic processing system 1. The arithmetic processing system 1 of the present invention is an arithmetic processing system for language processing that uses artificial intelligence (AI)-based communication software based on a general-purpose language model (preferably, a large language model) to perform an arithmetic operation for language processing. Note that the language model is preferably a large language model (LLM), but the language model does not necessarily have to be large-scale. In addition, as the language model, an existing appropriate language model such as ChatGPT provided by OpenAI can be used. These language models create and output a text considered to be related to an input word or sentence.

For example, the arithmetic processing system 1 functions as a text string creation assistance system having a text string creation function of creating, for characters (keyword) designated by the user, a text string constituting a part or all of a text such as a novel, a script, a screenplay, an academic paper, an article, an email magazine, or an SNS post.

The text string generated by the text string creation function of the present invention is a text string representing one or more words as a sentence or a constituent element of the sentence. In addition, the text string generated by the text string creation function includes a text string for each hierarchical level (a text string of each of a plurality of hierarchical levels) in a text having a hierarchical structure. For example, the text string generated by the text string creation function includes a title, a heading, a body, and the like of a text. In this case, the title can be a text string in the highest hierarchical level (first hierarchical level), the heading can be a text string in a lower hierarchical level (second hierarchical level) immediately below the first hierarchical level, and the body can be a text string in a lower hierarchical level (third hierarchical level) immediately below the second hierarchical level. Note that the hierarchical structure of the text string is an example, and the hierarchical structure of the text string varies depending on the text, and thus is appropriately set according to the property of the text. For example, in a case where the heading is divided into a plurality of hierarchical levels, the text string generated by the text string creation function includes the heading of each hierarchical level.

As illustrated in FIG. 1, the arithmetic processing system 1 includes a management server 2 and a plurality of user terminals 3, and the management server 2 and the plurality of user terminals 3 are communicably connected to each other via a communication line (network) 4 such as the Internet.

The management server 2 includes a general-purpose server computer. The user terminal 3 is a computer used by a user of the present system, and includes a general-purpose computer (terminal) including a display means such as a tablet PC, a desktop PC, a laptop PC, or a smartphone. Note that the management server 2 may include one server computer or a plurality of server computers.

The management server 2 includes a control unit 21, an input unit 22, a display unit (display device) 23, a communication unit 24, and an auxiliary storage unit 25, and has a function as a web server. Each of the input unit 22, the display unit 23, the communication unit 24, and the auxiliary storage unit 25 is connected to the control unit 21.

The user terminal 3 includes a control unit 31, an input unit 32, a display unit (display device) 33, a communication unit 34, and an auxiliary storage unit 35. Each of the input unit 32, the display unit 33, the communication unit 34, and the auxiliary storage unit 35 is connected to the control unit 31.

The control unit 21 includes an arithmetic unit 26 and a main storage unit 27, and executes various arithmetic operations and control operations in the management server 2. The control unit 31 includes an arithmetic unit 36 and a main storage unit 37, and executes various arithmetic operations and control operations in the user terminal 3.

The arithmetic unit (26, 36) is an arithmetic processing unit including a CPU, an MPU, or the like. The main storage units 27 and 37 include a RAM (DRAM), a ROM, and the like. The RAM is used as a work area and a buffer area of the arithmetic unit (26, 36). The ROM stores a startup program of the management server or the user terminal 3, default values for various types of information, and the like.

The input unit (22, 32) includes an input component which receives a user's operation input and an input detection circuit which is interposed between the input component and the arithmetic unit (26, 36). The input component is, for example, a keyboard or/and a computer mouse, and in a case where the input component is a keyboard, the input component includes an operation button or an operation key of hardware. In addition, a touch panel may be used as the input component. The input detection circuit outputs, to the arithmetic unit (26, 36), an operation signal or operation data corresponding to an operation of each input component.

The display unit (23, 33) includes a display and a display control circuit interposed between the display and the arithmetic unit (26, 36). As the display, for example, a liquid crystal display (LCD), an organic EL display, or the like can be used.

The communication unit (24, 34) includes a communication circuit for connection to the communication line 4. The communication circuit is a wired communication circuit or a wireless communication circuit, and communicates with an external computer via the communication line 4 in accordance with an instruction from the arithmetic unit (26, 36). In addition, the communication unit (24, 34) can communicate with a computer or system constituting the language model via the communication line 4.

The auxiliary storage unit (25, 35) includes a non-volatile memory such as an HDD, an SSD, a flash memory, or an EEPROM, and stores a control program and various types of data for the arithmetic unit (26, 36) to control the operation of the management server 2 or the user terminal.

The auxiliary storage unit 25 of the management server 2 stores a management program 28 for executing various operations of the management server 2 and management data 29 necessary for use of the present system. In the present embodiment, the management program 28 includes at least a program for accessing a language model (for performing language processing using the language model).

The management program 28 and the management data 29 are read from the auxiliary storage unit 25 as necessary and stored (deployed) in the main storage unit 27 (RAM). The operation of the management server 2 is realized by the arithmetic unit 26 executing the management program 28 deployed in the main storage unit 27 (RAM).

The auxiliary storage unit 35 of the user terminal 3 stores a user program 38 for executing various operations of the user terminal 3 in the present system according to an operation input of the user, and user data 39 necessary for use of the present system. In the present embodiment, the user program 38 includes at least a program for accessing the management server 2.

The user program 38 and the user data 39 are read from the auxiliary storage unit 35 as necessary and stored (deployed) in the main storage unit 37 (RAM). The operation of the user terminal 3 is realized by the arithmetic unit 36 executing the user program 38 deployed in the main storage unit 37 (RAM).

Note that the configuration of the management server 2 and the configuration of the user terminal 3 illustrated in FIG. 1 are merely examples, and the present invention is not limited thereto.

### Example of System Operation

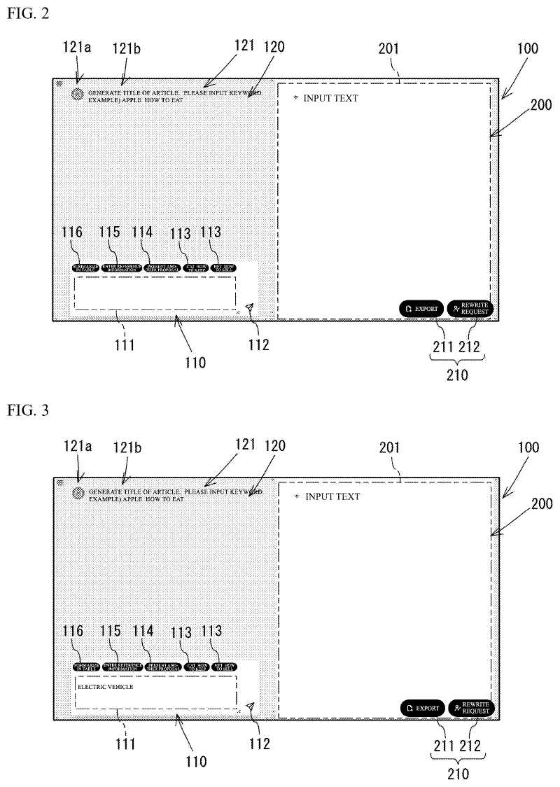

Hereinafter, an operation example of the arithmetic processing system 1 will be described with reference to FIGS. 2 to 9. When the user terminal 3 accesses the management server 2 according to the operation input of the user, an operation screen (menu screen) 100 for providing the text string creation function of the arithmetic processing system 1 is displayed on the display unit 33 (display) of the user terminal 3. Hereinafter, the menu screen 100 described with reference to FIGS. 2 to 9 is displayed on the display of the user terminal 3.

FIG. 2 is an explanatory diagram of a screen configuration of the menu screen 100 in an initial state. The menu screen 100 illustrated in FIG. 2 is an example of a screen to be displayed first among operation screens for providing the text string creation function.

As illustrated in FIG. 2, the menu screen 100 includes a keyword input section (text input section) 110 which receives input of one or more characters (keywords) that form a basis of a text string, a first text string display section 120 which displays the text string created by the text string creation function, a second text string display section 200 which is displayed side by side with the first text string display section 120 and displays the text string in an editable manner, and an output section 210 for outputting, as text data, the text string displayed in the second text string display section 200. The first text string display section 120 is arranged on a left side from a horizontal center in the display area of the menu screen 100, and the second text string display section 200 is arranged on a right side from the horizontal center in the display area of the menu screen 100. That is, the first text string display section 120 and the second text string display section 200 are arranged side by side in a horizontal direction. In addition, the sizes of respective display areas of the first text string display section 120 and the second text string display section 200 are substantially the same.

Furthermore, the keyword input section 110 is arranged at the lower end of the first text string display section 120. The output section 210 is arranged at the lower end of the second text string display section 200.

The keyword input section 110 includes a text box (keyword input field) 111 which receives input of a keyword. The user can input an arbitrary keyword in the keyword input field by using the input unit 32.

As illustrated in FIG. 3, when a keyword is input, the keyword is displayed in the keyword input field. The keyword input field can receive editing of characters (editing of a keyword) including deletion of characters, addition of characters, change of characters, and the like for the input keyword. In addition, a plurality of keywords can be input into the keyword input field 111 by being separated by a blank (space), a comma, or the like.

In addition, the keyword input section 110 is provided with a keyword setting button 112 to which a function of setting (determining) a keyword input to the keyword input section 110 (keyword input field 111) as a keyword for text string creation is allocated, and a plurality of shortcut buttons 113. Each of the keyword setting button 112 and the shortcut buttons 113 functions as a software key (operation button). Hereinafter, the software key is referred to as a “button”.

One or more keywords registered in advance are associated with each of the plurality of shortcut buttons 113, and when the shortcut button 113 is selected, the keyword associated with the selected shortcut button 113 is automatically set as the keyword for text string creation.

Furthermore, the keyword input section 110 is provided with a different plan display button 114 for displaying a text string (different plan) different from the text string displayed in the first text string display section 120, a reference information button 115 for additionally displaying reference information regarding the text string displayed in the first text string display section 120, and a table addition display button 116 for displaying information indicated by the text string displayed in the first text string display section 120 in a table format. Here, each of the shortcut button 113, the different plan display button 114, the reference information button 115, and the table addition display button 116 is colored in a predetermined color (first color) different from the background color of the menu screen 100 and the color of characters in another portion.

When the keyword setting button 112 or the shortcut button 113 is selected, the arithmetic processing system 1 proceeds to text string generation processing of automatically generating the text string related to the keyword for text string creation input in the text box (keyword input field) 111 by using the language model.

In the text string generation processing, the input text (text prompt) optimized from the viewpoint of text generation according to the characteristics of the language model and the type of the text string to be an output target (generation target) is generated on the basis of the meaning of the keyword for text string creation, and is input to the language model. The input text is generated by selecting an answer request sentence, which is most appropriate for the input keyword for text string creation, from a plurality of answer request sentences registered in advance, and applying the keyword for text string creation to a blank space for keyword application provided in the answer request sentence. The answer request sentence is registered by adjusting in advance a sentence in a question format in which the language model (artificial intelligence) can easily appropriately output the text string of the answer. For example, when “electric vehicle” is input as a keyword, as the answer request sentence, a text string “Please suggest a title that can be expected to be displayed in high order in the Internet search as an explanation sentence of the electric vehicle.” is generated as a text prompt and is input to the language model. Then, a text string corresponding to the text prompt is output (generated) from the language model. The answer request sentence can be appropriately changed from an administrator page. In this way, the user can freely set the answer request sentence and can immediately reflect the answer request sentence.

Here, the text string output from the language model includes a text string for each hierarchical level (a text string constituting each hierarchical level) in a text having a hierarchical structure. In the present embodiment, the text string to be output includes a title, a heading, a body, and the like of a text. The hierarchical levels of the text string include a title (first hierarchical level, highest level), a heading (second hierarchical level, lower level), and a body (third hierarchical level, lowest level) in order from the higher hierarchical level. In the text string generation processing of the present embodiment, first, a title is generated as a text string in the highest hierarchical level on the basis of a keyword for text string creation, then a heading related to the title is generated, and then a body is generated from the heading. Note that the type of the text string is not particularly limited, and what kind of text string is generated in what order is not particularly limited. In addition, the number of necessary hierarchical levels may be different depending on the type of a text to be created. Therefore, the number of hierarchical levels, the number of answer request sentences, and the content of the answer request sentence can be appropriately changed from the administrator page.

As illustrated in FIGS. 2 and 3, an initial message 121 displayed in advance is displayed in the first text string display section 120. The initial message 121 is displayed at the top of the first text string display section 120, and includes a system-side icon 121a and an example input sentence 121b showing an example of input to the keyword input section 110. The system-side icon 121a is displayed in a mode indicating that the message is a message from the system side, and is colored in a color different from at least the first color. This also applies to system-side icons 130a, 140a, and 150a to be described later.

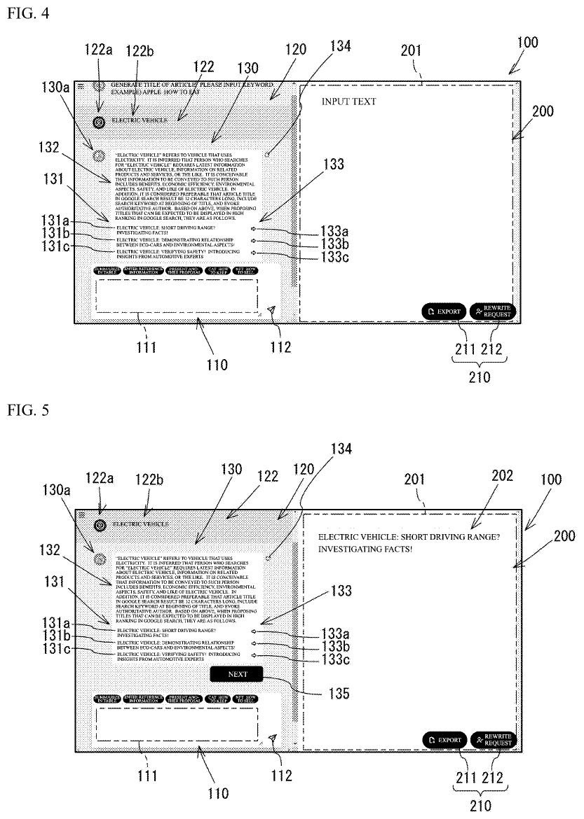

When the keyword for text string creation is set, first text string generation processing (first-level text string generation processing) is executed. When the first text string generation processing is executed, as illustrated in FIG. 4, a keyword setting message 122 indicating the set keyword for text string creation is displayed in the first text string display section 120. FIG. 4 illustrates a case where characters “electric vehicle” are set as a keyword for text string creation.

In the first text string display section 120, a new message is displayed below and adjacent to the previous message. In the example illustrated in FIG. 4, the keyword setting message 122 is displayed below and adjacent to the initial message 121. The keyword setting message 122 includes a user-side icon 122a indicating that the message has been generated by an action of the user and a keyword display section 122b indicating a keyword for text string creation. In addition, the user-side icon 122a is colored in a first color.

As described above, in the first text string generation processing of the present embodiment, the text string (first-level text string) corresponding to the title of the text is generated as the text string of the highest hierarchical level. In addition, in the present embodiment, a plurality of titles of the text related to the keyword for text string creation are generated. Therefore, when the first text string generation processing is executed, a title display message (first-level text string display message) 130 indicating a plurality of titles (title candidates) is displayed in the first text string display section 120. A plurality of title candidates related to the keyword “electric vehicle” for text string creation are displayed in FIG. 4.

The title display message 130 is displayed below and adjacent to the keyword setting message 122. That is, title generation processing (first-level text string generation processing) as a type of the text string generation processing and title display processing (first-level text string display processing) for displaying the generated title are executed.

The title display message 130 includes a system-side icon 130a, a title display section (first-level text string display section) 131 including a text string indicating a title candidate, an inference process display section 132 including a sentence indicating a process (inference process) of deriving the title candidate (first-level text string) from a keyword for text string creation, and a text string selection button 133 displayed in association with the title candidate.

In addition, a retry button 134 is provided in the vicinity of the title display message 130. When the retry button 134 is selected, the title generation processing and the title display processing are executed again, a title candidate is newly generated, and the title display message 130 corresponding to the newly generated title candidate is displayed. In addition, in a case where the retry button 134 is selected, an answer request sentence different from the previously selected answer request sentence is selected, whereby a text prompt different from the previous text prompt is generated, and the title candidate is different from the previous one.

A plurality of text strings corresponding to a plurality of title candidates are displayed in the title display section 131. In the present embodiment, three text strings 131a to 131c corresponding to three title candidates are displayed. In addition, as the text string selection button 133, three text string selection buttons 133a to 133c are provided corresponding to the three text strings 131a to 131c.

Here, in the title display message 130, the inference process display section 132 is displayed on the upper side, and the title display section 131 and the text string selection button 133 are displayed below the inference process display section 132. In this way, the user can recognize the inference process from the keyword for text string creation to the title candidate. Therefore, the validity of the title candidate as an answer on the system side can be examined, or a problem point in a case where the title candidate is inappropriate can be found from the inference process, and the keyword for text string creation can be changed. In this way, the possibility of obtaining an appropriate answer is increased, and the user convenience can be improved.

When the text string selection button 133 (one of the text string selection buttons 133a to 133c) is selected, the processing proceeds to title duplication processing (first-level text string duplication processing) of duplicating the selected title (first-level text string). In the title duplication processing, a duplicate text string (duplicate title) obtained by duplicating the title associated with the selected text string selection button 133 is displayed in the second text string display section 200. At this time, hierarchy tag data (first-level tag data) indicating that the text string is a title (first-level text string) is associated with the duplicate text string duplicated in the title duplication processing.

A case where the text string selection button 133a is selected will be described as an example. As illustrated in FIG. 5, when the text string selection button 133a is selected, a duplicate title (a duplicate text string in the first hierarchical level) 202 obtained by duplicating a text string “Electric Vehicle: Short Driving Range? Investigating Facts!” as the title associated with the text string selection button 133a is displayed in an editable text box (editing field) 201 of the second text string display section 200. Since the text displayed in the editing field 201 is editable, the duplicate title 202 can be used as it is, or the duplicate title 202 can be partially edited. The text displayed in the editing field 201 is edited by an appropriate method in which a cursor (not illustrated) is set at an arbitrary place of the text, and characters are input by the input unit 22 at the position, or a delete key is selected if any.

In addition, when the duplicate text string is added to the second text string display section 200, a lower-level text string generation button 135 for generating a text string of a hierarchical level (second hierarchical level) lower than the hierarchical level (first hierarchical level) of the duplicate text string of the lowest hierarchical level (the duplicate text string 202 of the first hierarchical level in the present embodiment) displayed in the second text string display section 200 is displayed below the title display message 130. In addition, the lower-level text string generation button 135 is colored in the first color. When the lower-level text string generation button 135 is selected, the arithmetic processing system 1 proceeds to second-level text string generation processing and generates a second-level text string related to the duplicate text string of the first hierarchical level.

In the second-level text string generation processing of the present embodiment, a heading related to the title displayed in the second text string display section 200 is generated as the second-level text string. That is, the second-level text string generation processing of the present embodiment can be referred to as heading generation processing.

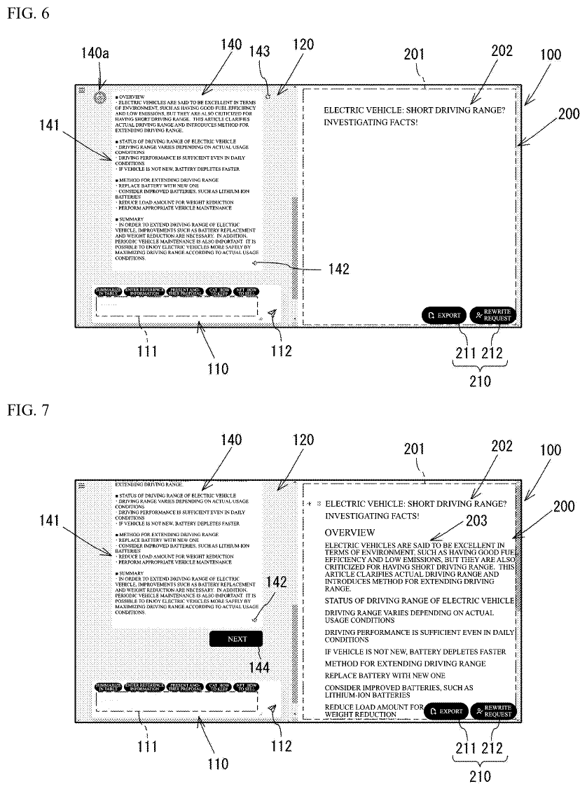

As illustrated in FIG. 6, when the heading generation processing is executed, a heading display message 140 for displaying a heading is displayed in the first text string display section 120. That is, the heading generation processing as a type of the text string generation processing and heading display processing (second-level text string display processing) of displaying a generated heading are executed. Although it is difficult to understand from the drawings, the heading display message 140 is displayed below and adjacent to the title display message 130 and the lower-level text string generation button 135.

The heading display message 140 includes the system-side icon 140a, a heading display section 141 which displays a heading (second-level text string), and a text string selection button (heading selection button) 142 associated with the heading (second-level text string) displayed in the heading display section 141.

In addition, a retry button 143 is provided in the vicinity of the heading display message 140. When the retry button 143 is selected, the heading generation processing and the heading display processing are executed again, a heading is newly generated, and the heading display message 140 corresponding to the newly generated heading is displayed. In addition, in a case where the retry button 143 is selected, an answer request sentence different from the previously selected answer request sentence is selected, whereby a text prompt different from the previous text prompt is generated, and the heading is different from the previous heading.

The heading display section 141 displays the heading related to the title displayed in the second text string display section 200. However, the heading of the present embodiment includes a plurality of headings related to the title. An order (an order in a text) is automatically allocated to each of the plurality of headings. In addition, in the present embodiment, the headings are generated, divided into two hierarchical levels of major headings (headings of parent sections) and subheadings (headings of child sections). In addition, a mark image indicating the head of the text string of the heading is displayed at the head portion (the left end in the present embodiment) of each heading. Furthermore, the mark image is an image different for each hierarchical level of the headings (an image by which the hierarchical level of the heading can be identified). For example, the mark image of the major heading and the mark image of the subheading are different images. Therefore, the hierarchical level of the heading can be easily recognized. Note that, the heading may be generated, divided into three or more hierarchical levels such as minor headings of a level smaller than the subheading (headings of grandchild sections) in addition to the major heading and the subheading.

The heading selection button 142 is arranged at the lower end of the heading display message 140. When the heading selection button 142 is selected, the processing proceeds to heading duplication processing (second-level text string duplication processing) of duplicating the heading (second-level text string). In the heading duplication processing, a duplicate text string (duplicate heading) obtained by duplicating the heading associated with the heading selection button 142 is displayed in the second text string display section 200. At this time, hierarchy tag data (second-level tag data) indicating that the text string is a heading (second-level text string) is associated with the duplicate text string duplicated in the heading duplication processing.

For example, as illustrated in FIG. 7, when the heading selection button 142 is selected, a duplicate heading (a duplicate text string of the second hierarchical level) 203 obtained by duplicating the heading displayed in the heading display section 141 is displayed in the editing field 201 of the second text string display section 200. Since the text displayed in the editing field 201 is editable, the duplicate heading 203 displayed in the editing field 201 can be used as it is, or the duplicate heading 203 can be partially edited. As described above, according to the present invention, the title and the heading (outline) related to the keyword for text string creation can be easily displayed in an editable state. Note that a heading can also be directly input to the second text string display section 200.

Here, the duplicate heading (the duplicate text string of the second hierarchical level) 203 is arranged below the duplicate title (the duplicate text string of the first hierarchical level) 202. In addition, the size of the characters of the duplicate heading 203 is set to be smaller than the size of the characters of the duplicate title 202. Furthermore, among the characters of the duplicate heading 203, the size of the characters corresponding to the major heading is set to be larger than the size of the characters corresponding to the subheading. As described above, the size of the characters is automatically set according to the hierarchical order of the text string, so that it is easy to recognize the hierarchical level of the text string. The size of the characters in the second text string display section 200 is determined according to the hierarchy tag data, and is set to be larger at higher hierarchical levels (smaller at lower hierarchical levels).

In addition, when the heading selection button 142 is selected, a lower-level text string generation button 144 for generating a text string of a hierarchical level (third hierarchical level) lower than the hierarchical level (second hierarchical level) of the duplicate text string of the lowest hierarchical level (the duplicate heading 203 in the present embodiment) displayed in the second text string display section 200 is displayed below the heading display message 140. In addition, the lower-level text string generation button 144 is colored in the first color. When the lower-level text string generation button 144 is selected, the arithmetic processing system 1 proceeds to third-level text string generation processing and generates a third-level text string related to the duplicate text string of the second hierarchical level.

In the third-level text string generation processing of the present embodiment, a body related to the heading displayed in the second text string display section 200 is generated as the third-level text string. That is, the third-level text string generation processing of the present embodiment can be referred to as body generation processing. In addition, in the present embodiment, the third hierarchical level is set as a hierarchical level corresponding to the body (body hierarchical level), and a hierarchical level (second hierarchical level) immediately above the third hierarchical level as the body hierarchical level is a hierarchical level (trigger hierarchical level) of a trigger for creating the body. After the text string of the trigger hierarchical level is generated and duplicated, a body for each of the text strings of the trigger hierarchical level is sequentially created. In the present embodiment, the body for each of the text strings in the second hierarchical level as the trigger hierarchical level is sequentially created. In addition, the hierarchy tag data of the trigger hierarchical level (the second-level tag data in the present embodiment) is associated with data indicating the trigger hierarchical level.

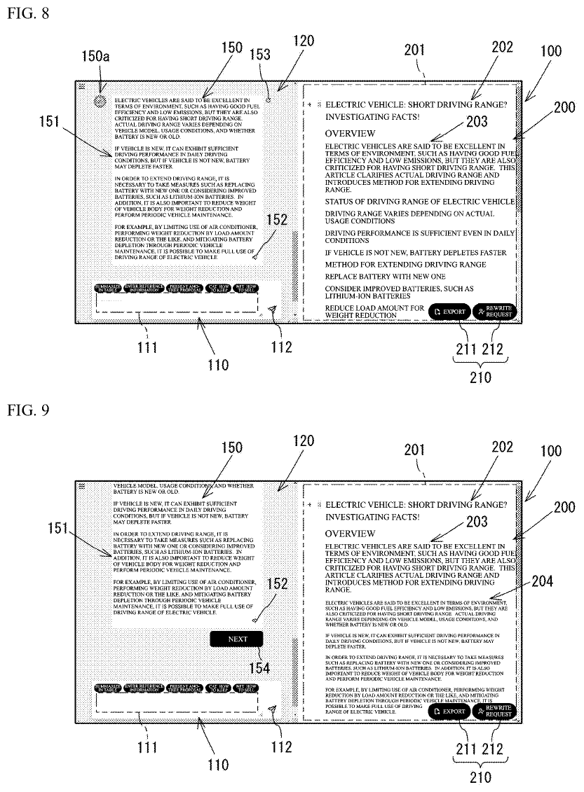

As illustrated in FIG. 8, when the body generation processing is executed, a body display message 150 for displaying a body is displayed in the first text string display section 120. That is, the body generation processing as a type of the text string generation processing and body display processing (third-level text string display processing) of displaying a generated body are executed. Although difficult to understand from the drawings, the body display message 150 is displayed below and adjacent to the heading display message 140 and the lower-level text string generation button 144.

The body display message 150 includes the system-side icon 150a, a body display section 151 which displays a body (third-level text string), and a text string selection button (body selection button) 152 associated with the body (third-level text string) displayed in the body display section 151.

In addition, a retry button 153 is provided in the vicinity of the body display message 150. When the retry button 153 is selected, the main body generation processing and the main body display processing are executed again, a body is newly generated, and the body display message 150 corresponding to the newly generated body is displayed. In addition, in a case where the retry button 153 is selected, an answer request sentence different from the previously selected answer request sentence is selected, whereby a text prompt different from the previous text prompt is generated, and the body is different from the previous body.

The body display section 151 displays the body related to the heading displayed in the second text string display section 200. Here, the body is generated one by one for each heading according to the order of the headings. In the example illustrated in FIG. 8, the body display section 151 displays the heading “Summary” to which the highest order is allocated and the body related to “Electric vehicles are . . . having good fuel efficiency . . . (omitted) . . . and introduces . . . ”.

The body selection button 152 is arranged at the lower end of the body display message 150. When the body selection button 152 is selected, the processing proceeds to body duplication processing (third-level text string duplication processing) of duplicating the body (third-level text string). In the body duplication processing, a duplicate text string (duplicate body) obtained by duplicating the body associated with the body selection button 152 is displayed in the second text string display section 200. At this time, hierarchy tag data (third-level tag data) indicating that the text string is a body (third-level text string) is associated with the duplicate text string duplicated in the body duplication processing.

For example, as illustrated in FIG. 9, when the body selection button 152 is selected, a duplicate body (a duplicate text string of the third hierarchical level) 204 obtained by duplicating the body displayed in the body display section 151 is displayed in the editing field 201. Since the text displayed in the editing field 201 is editable, the duplicate body 204 displayed in the editing field 201 can be used as it is, or the duplicate body 204 can be partially edited. As described above, according to the present invention, the title, the heading, and the body related to the keyword for text string creation can be easily displayed in an editable state.

Here, the duplicate body (the duplicate text string of the third hierarchical level) 204 is arranged below (directly below) the corresponding duplicate heading (the duplicate text string of the second hierarchical level) 203. In addition, the size of the characters of the duplicate body 204 is set to be smaller than the sizes of the characters of the duplicate title 202 and the duplicate heading 203. As described above, the size of the characters is automatically set according to the hierarchical order of the text string, so that it is easy to recognize the hierarchical level of the text string.

In addition, after the duplicate body 204 is displayed and when there is a heading (duplicate heading) for which the body has not been generated, a same-level text string generation button 154 for generating a body (a text string of the same hierarchical level) related to a heading in the next order is displayed below the body display message 150. When the same-level text string generation button 154 is generated, the processing proceeds to the body generation processing for generating a body related to a heading in the next order and the body display processing. Here, in the text strings of the second hierarchical level as the trigger hierarchical level, a body is sequentially created for the text string for which the body has not been generated. In addition, the hierarchy tag data of the trigger hierarchical level (the second-level tag data in the present embodiment) is associated with flag data indicating whether the body is generated. By repeating the body generation processing and the body display processing in this manner, it is possible to display the bodies related to all the headings and display the duplicate text strings 202 to 204 constituting the text including the title, the headings, and the bodies in the editing field 201 of the second text string display section 200.

Then, by utilizing the function of the output section 210, the duplicate text string displayed in the editing field 201 of the second text string display section 200 can be output as text data. The output section 210 is provided with an export button 211 and a rewrite request button 212. To the export button 211, a function of outputting the duplicate text string displayed in the editing field 201 of the second text string display section 200 as text data that can be handled by the user terminal 3 is allocated. To the rewrite request button 212, a function of requesting rewrite (addition correction) by transmitting the duplicate text string displayed in the editing field 201 of the second text string display section 200 to a third party is allocated. Note that the third party can be an expert such as a writer, or can be artificial intelligence-based software.

With the above configuration and operation, only by setting a keyword for text string creation, it is possible to automatically generate a text string for each hierarchical level in the text by the language model and to display the duplicate text string obtained by duplicating the text string. Therefore, in the present invention, a work can be made much simpler than the related art, and the user convenience can be improved.

In addition, according to the present invention, since the text string for each hierarchical level in the text is individually generated and displayed in order from the higher hierarchical level, it is not necessary for the user to process a lot of information at a time, and this allows the text to be created sequentially, whereby considerably excellent operability can be realized and the user convenience can be improved.

Furthermore, according to the present invention, since the duplicate text string can be output as text data, it is possible to easily create a text by utilizing the duplicate text string displayed in the editing field 201 of the second text string display section 200.

In addition, according to the present invention, by using the answer request sentence, the input keyword can be adjusted to a text that can be easily analyzed by the language model, and an appropriate answer can be more reliably obtained from the language model. In addition, since a text prompt to be input into the language model is generated from the answer request sentence and the keyword, it is possible to easily obtain an optimum result with a simple operation.

The text string creation assistance system according to the present invention corresponds to the arithmetic processing system 1. Similarly, the display device corresponds to the display unit 33, the menu screen corresponds to the menu screen 100, the keyword input section corresponds to the keyword input section 110, the keyword setting section corresponds to the keyword setting button 112, the first text string display section corresponds to the first text string display section 120, the second text string display section corresponds to the second text string display section 200, the text string selection button corresponds to the text string selection button 133, 142, 152, the duplication processing corresponds to the first-level text string duplication processing, the second-level text string duplication processing, and the third-level text string duplication processing, the keyword setting button corresponds to the keyword setting button 112 or the shortcut button 113, the second-level text string generation button corresponds to the lower-level text string generation button 135, the third-level text string generation button corresponds to the lower-level text string generation button 144, and the output section corresponds to the output section 210. However, the present invention is not limited to the present embodiment, and various other embodiments can be adopted. In addition, the screen, the specific configuration, and the like described in the above-described embodiments are merely examples, and can be appropriately changed according to an actual product.

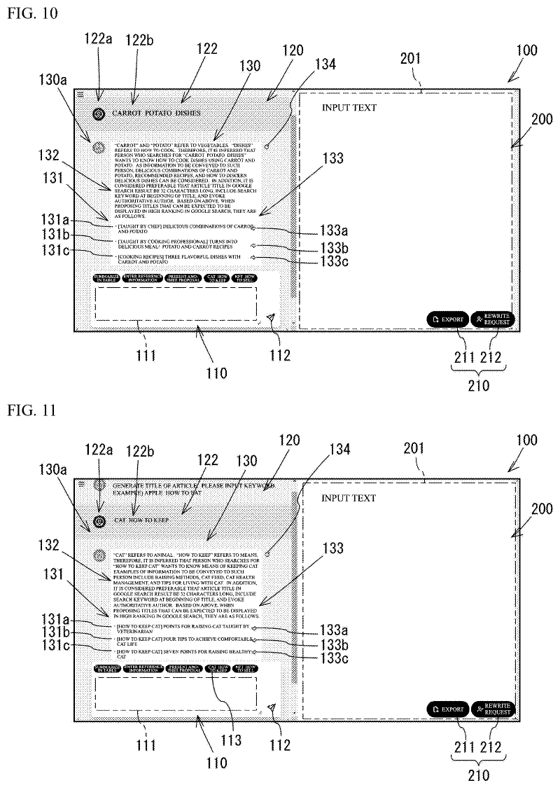

For example, as illustrated in FIG. 10, a plurality of keywords can be set as keywords for text string creation. In this case, an optimized text prompt is generated according to the meaning of each of the plurality of keywords for text string creation, and a text string corresponding to the text prompt is output from the language model.

In addition, as illustrated in FIG. 11, by operating the shortcut button 113, the keyword associated with the selected shortcut button 113 can be set as a keyword for text string creation. In this case, the keyword input work can be omitted, so that excellent operability can be realized, and user convenience can be improved.

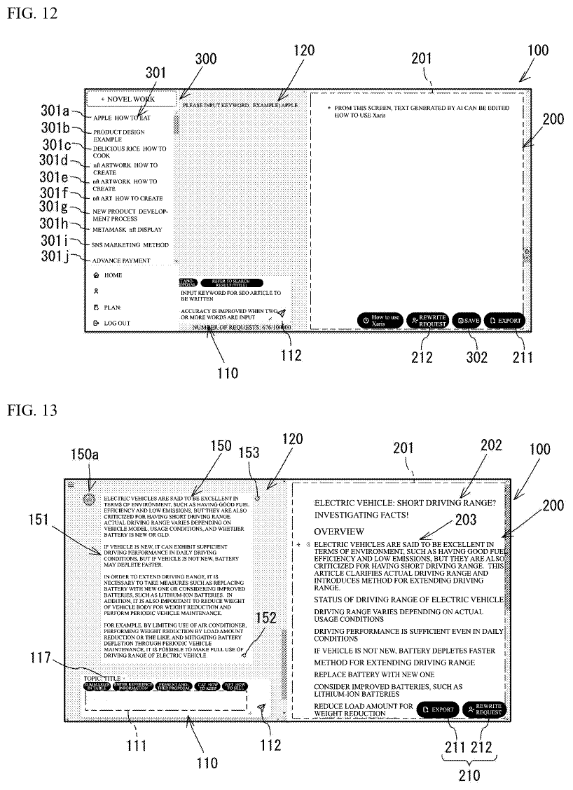

Furthermore, data (registration data) of a text string generated in the past may be read. For example, as illustrated in FIG. 12, a registration data reading section 300 for reading the registration data may be displayed on the menu screen 100. The registration data reading section 300 includes a data selection section 301 for selecting the registration data registered in the storage unit of the arithmetic processing system 1 (the auxiliary storage unit 25 of the management server 2 or an appropriate storage unit such as an external storage). The data selection section 301 includes a plurality of selection buttons 301a to 301j allocated for each registration data. When any one of the plurality of selection buttons 301a to 301j is selected, the registration data allocated to the selected button is read. The data of the generated text string may be automatically registered, or may be registered when a save button (registration button) 302 provided on the menu screen 100 is selected. In this way, the text string data created so far can be completed later or the text string data used in the past can be referenced, which is convenient.

Furthermore, as illustrated in FIG. 13, a hierarchical level designation section 117 for designating a hierarchical level in which the text string generation processing is performed may be displayed on the menu screen 100. The hierarchical level designation section 117 can designate any hierarchical level of the already created hierarchical level or a hierarchical level immediately below the already created lowest hierarchical level by an appropriate method such as a pull-down menu. In this case, in the text string generation processing, the text string of the hierarchical level designated by the hierarchical level designation section 117 is generated. In a case where the already created hierarchical level is designated, the text string of the same hierarchical level is generated again. In this way, the text string generated once can be regenerated. That is, a necessary text string can be corrected at a necessary timing, which is convenient.

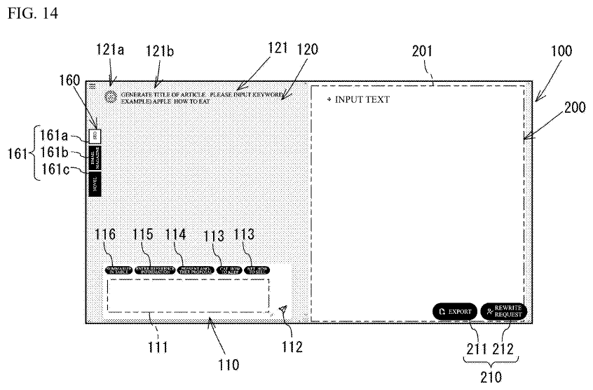

In addition, as illustrated in FIG. 14, a text type selection section 160 for selecting the type of the text to be created may be displayed on the menu screen 100. The text type selection section 160 includes a plurality of selection buttons 161 respectively allocated to a plurality of types of texts. In the present embodiment, in the text type selection section 160, “SEO article”, “email magazine”, and “novel” can be selected as the type of text. Accordingly, the text type selection section 160 includes a selection button 161a allocated to the SEO article, a selection button 161b allocated to the email magazine, and a selection button 161c allocated to the novel. In addition, the trigger hierarchical level is set to an appropriate hierarchical level according to the type of text. In this way, an appropriate text string can be generated according to the type of text selected by the user.

Furthermore, the present invention can be provided not only as a text string creation assistance system but also as a method for assisting in text string creation by using the text string creation assistance system, a program, and a non-transitory (non-transient) tangible storage medium storing the program.

### INDUSTRIAL APPLICABILITY

The present invention can be used in an industry that provides assistance in text creation by using a language model.

### REFERENCE SIGNS LIST

1 data management system
2 management server
3 user terminal
31 control unit
32 input unit
33 display unit
4 communication line
100 menu screen
110 keyword input section
112 keyword setting button
120 first text string display section
133, 133a, 133b, 133c text string selection button
135, 144 lower-level text string generation button
200 second text string display section
210 output section

1. A text string creation assistance system comprising:
a display device which displays a menu screen for creating a text string constituting a part or all of a text,
wherein the menu screen includes
a keyword input section which receives input of one or more keywords,
a keyword setting section which sets a keyword input to the keyword input section as a keyword for text string creation,
a first text string display section which displays a text string related to the keyword for text string creation generated using a language model,
a second text string display section which is displayed side by side with the first text string display section and displays a text string in an editable manner, and
a text string selection button which is displayed in association with the text string in the first text string display section, and
when the text string selection button is selected, processing proceeds to duplication processing of displaying, in the second text string display section, a duplicate text string obtained by duplicating the text string associated with the text string selection button.

2. The text string creation assistance system according to claim 1, wherein
the text string includes a text string for each hierarchical level in the text having a hierarchical structure,
the keyword setting section includes a keyword setting button to which a function of setting the keyword input to the keyword input section as the keyword for text string creation is allocated, and
when the keyword setting button is selected, a first-level text string that is a text string of the highest hierarchical level related to the keyword for text string creation is generated by using the language model, and processing proceeds to first-level text string display processing of displaying the first-level text string in the first text string display section.

3. The text string creation assistance system according to claim 2, wherein
the text string includes a second-level text string which is a text string of a lower hierarchical level than the first-level text string and is related to the first-level text string,
the menu screen further includes a second-level text string generation button which is displayed after the first-level text string is displayed in the first text string display section, and
when the second-level text string generation button is selected, a second-level text string related to the first-level text string is generated by using the language model, and processing proceeds to second-level text string display processing of displaying the generated second-level text string in the first text string display section.

4. The text string creation assistance system according to claim 3, wherein
the text string includes a third-level text string which is a text string of a lower hierarchical level than the second-level text string and is related to the second-level text string,
the menu screen further includes a third-level text string generation button which is displayed after the second-level text string is displayed in the first text string display section, and
when the third-level text string generation button is selected, a third-level text string related to the second-level text string is generated by using the language model, and processing proceeds to third-level text string display processing of displaying the generated third-level text string in the first text string display section.

5. The text string creation assistance system according to claim 1, wherein the menu screen further includes an output section which outputs, as text data, the duplicate text string displayed in the second text string display section.

6. A text string creation assistance method, comprising:
by using a display device which displays a menu screen for creating a text string constituting a part or all of a text, the menu screen including a keyword input section which receives input of one or more keywords, a keyword setting section which sets a keyword input to the keyword input section as a keyword for text string creation, a first text string display section which displays a text string related to the keyword for text string creation generated using a language model, a second text string display section which is displayed side by side with the first text string display section and displays a text string in an editable manner, and a text string selection button which is displayed in association with the text string in the first text string display section,
when the text string selection button is selected, proceeding to duplication processing of displaying, in the second text string display section, a duplicate text string obtained by duplicating the text string associated with the text string selection button.

7. A text string creation assistance program which causes
a computer of a display device which displays a menu screen for creating a text string constituting a part or all of a text, the menu screen including a keyword input section which receives input of one or more keywords, a keyword setting section which sets a keyword input to the keyword input section as a keyword for text string creation, a first text string display section which displays a text string related to the keyword for text string creation generated using a language model, a second text string display section which is displayed side by side with the first text string display section and displays a text string in an editable manner, and a text string selection button which is displayed in association with the text string in the first text string display section, to function as
a duplicate text string display means which, when the text string selection button is selected, displays, in the second text string display section, a duplicate text string obtained by duplicating the text string associated with the text string selection button.
